(19) United States
(12) Patent Application Publication
(10) Pub. No.: US 2018/0014003 A1
(43) Pub. Date: Jan. 11, 2018

(54) Measuring Accuracy of Image Based Depth Sensing Systems

(71) Applicant: Intel Corporation, Santa Clara, CA (US)

(72) Inventors: Ginni Grover, Santa Clara, CA (US); Ramkumar Narayanswamy, Boulder, CO (US)

(21) Appl. No.: 15/704,143

(22) Filed: Sep. 14, 2017

Related U.S. Application Data
(62) Division of application No. 14/547,268, filed on Nov. 19, 2014.

(51) Int. Cl. H04N 13/02; H04N 13/00

(52) U.S. Cl. CPC H04N 13/025; H04N 13/0242; H04N 13/0296; H04N 2013/0081; H04N 2013/0077

(57) ABSTRACT

A special test target may enable standardized testing of performance of image based depth measuring systems. In addition, the error in measured depth with respect to the ground truth may be used as a metric of system performance. This test target may aid in identifying the limitations of the disparity estimation algorithms.

### CROSS-REFERENCE TO RELATED APPLICATIONS

This application is a divisional of U.S. patent application Ser. No. 14/547,268 filed Nov. 19, 2014.

### BACKGROUND

Multi-camera imaging is an emerging field of computational photography. While the multi-camera imager is suitable for many applications, measurement of scene depth using parallax (disparity) is one of its fundamental advantages and leads to the most promising applications. Multiple camera platforms capture the same scene from different perspectives. The images are processed to determine the relative shift of the objects from one image to the next. The objects closer to the camera show more lateral shift, while objects farther from the camera show reduced lateral shift. This relative shift is referred to as disparity and is used to calculate depth. Various algorithms can be used for disparity (therefore depth) estimation.

Depth measurement performance in image based depth measuring systems depends on camera parameters, relative camera positions and disparity error. The disparity error further depends on scene characteristics such as object texture and color, noise characteristics of the cameras, optical aberrations in the lens, and the estimation algorithms.

Currently no standard test targets exist for determining depth measuring performance of the depth sensing systems. Test targets exist for measuring various camera properties such as Macbeth ColorChecker to measure color response, ISO-12233 for sharpness, etc. But no test targets exist for determining depth sensing performance of the cameras.

### BRIEF DESCRIPTION OF THE DRAWINGS

Some embodiments are described with respect to the following figures:

FIG. 1A is a schematic depiction of a depth target with boards placed at different scene depths according to one embodiment;

FIG. 1B is a depth map of the scene with dark to white color representing farthest to closest distance according to one embodiment and a color bar in meters;

FIG. 2A is a ground truth depth map for one embodiment;

FIG. 2B is a measured depth map with color bar in meters for one embodiment;

FIG. 3A shows the geometry of 6+1 and 2+1 camera systems with a maximum baseline of 78 mm and all cameras being equally separated according to one embodiment;

FIG. 3B is a plot of errors for the systems of FIG. 3A in depth measurement according to one embodiment where the dashed line shows the theoretical error calculated for 0.2 pixel errors in disparity measurement and the solid line is for 0.1 pixel errors;

FIG. 4 is a camera image of a depth target with colored Dead-leaves chart at ten different depth positions according to one embodiment;

FIG. 5 is a flow chart for one embodiment;

FIG. 6 is a system depiction for one embodiment; and

FIG. 7 is a front elevational view for one embodiment.

### DETAILED DESCRIPTION

A special test target may enable standardized testing of performance of image based depth measuring systems. In addition, the error in measured depth with respect to the ground truth may be used as a metric of system performance. This test target may also aid in identifying the limitations of the depth measuring cameras and disparity estimation algorithms.

A well characterized scene with two dimensional customized charts stacked at different but known depths may be assembled. The charts may be “customized” in that they can have different textures because image-based depth measuring algorithm results are texture dependent. In general, higher spatial frequency texture is required on charts to measure depth.

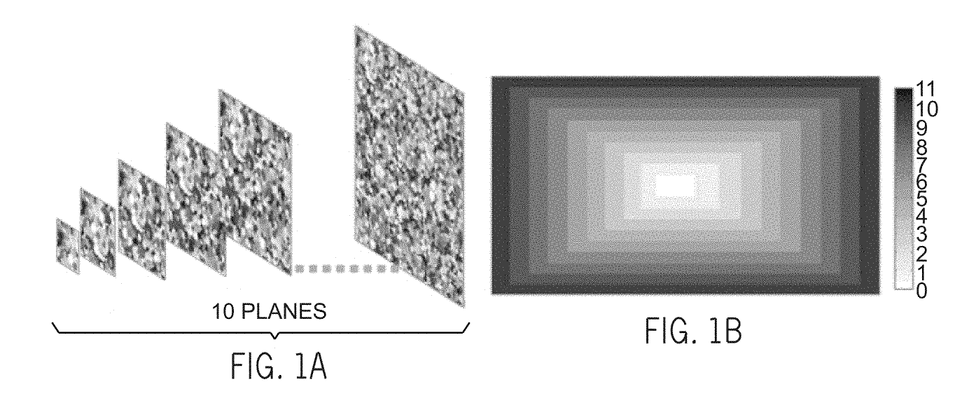

An example of the use of two dimensional charts is shown in FIG. 1A where a scene is generated with 10 boards of progressively larger size. In one embodiment, the boards are rectangular with their centers aligned but other known shapes may be used and non-aligned arrangements may also be used. The size of the boards is determined by field of view of the camera and the distance of the boards from the camera. An edge of each board may be less than 2*z*tan(θ/2) where z is the distance of the board from the camera and θ is the field of view of the camera along that direction. This size enables capturing the entire board in the camera.

Regarding the texture on these boards, a pattern on each board may be appropriately scaled with respect to its distance from the camera. This is because a camera magnifies objects based on their distance from it. Therefore, the same texture at shorter distances will exhibit lower spatial frequencies than at longer distances. So for the case when distance from the camera z2 is greater than distance from the camera z1, the displayed pattern on the board at distance z2 may be scaled by a factor of z2/z1 with respect to the displayed pattern on board at z1. This is done to make sure that the measured error in depth at different distances differs only due to the difference in depth and not due to difference in textures. The aim is to keep the spatial frequency content the same at different depths to make the error measurement independent of this parameter. Therefore, in practice if an image with a texture is displayed at a depth of 1 meter, the same image should be scaled up twice when placed at depth of 2 meters.

The ground truth depth map of this scene is shown in FIG. 1B with dark to light colors representing farthest to closest distance. The “ground truth” refers to a set of measurements known to be more accurate or exact. This scene is then captured with a depth sensing system and depth is estimated. The measured depth is compared against the ground truth and measurement accuracy reported.

A real target can be used for physical testing and a virtual image of such a real target via computer simulation may be used for testing. The added advantage of testing via computer simulation is knowledge of the exact ground truth depth map. A test target is modelled and digitally rendered via three-dimensional (3D) rendering packages plus added optical and sensor effects, thereby giving exact ground truth. Another consideration for the test target is the pattern to be displayed on the stacked boards.

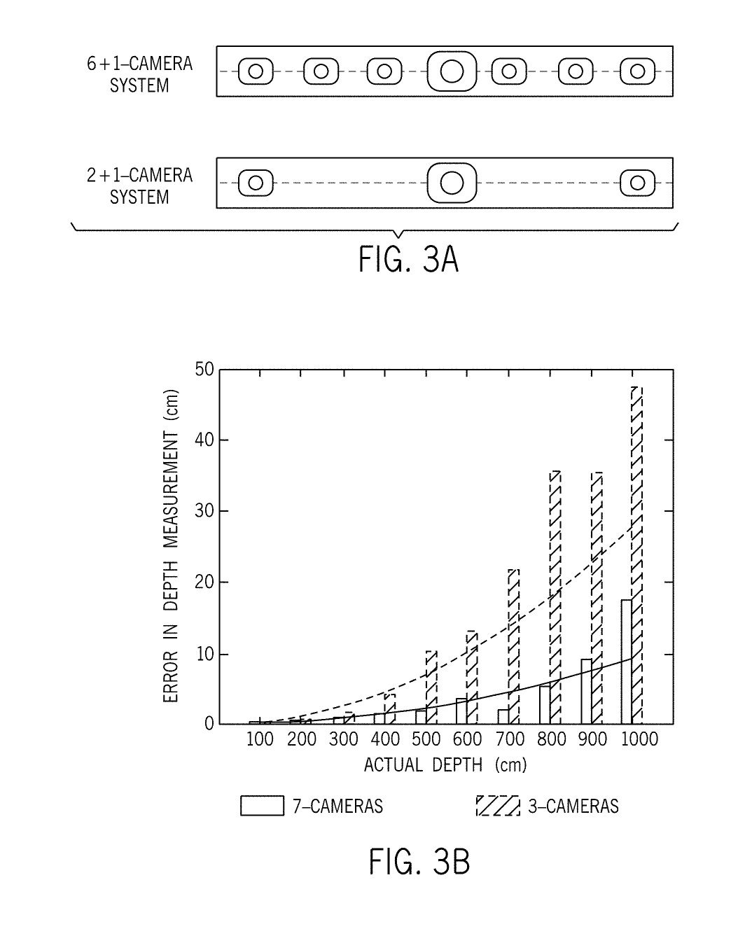

In one embodiment a 2+1-hybrid camera system may be compared with a 6+1-hybrid camera system. A 2+1 hybrid camera system has three cameras, two of which are two end cameras, as shown in FIG. 3A. The end cameras may be 1 megapixel resolution cameras and the center camera may be an 8 megapixel resolution camera in one embodiment. This is referred to as a hybrid multi-camera array. A similar convention applies for the 6+1-hybrid system having a center camera and three cameras to both sides of the center camera.

A depth target may use colored Dead-leaves charts at different depths in one embodiment. The Dead-leaves chart is known to have a wide range of spatial frequencies and to be scale-invariant i.e. scaling of the chart at different depths is not required to keep the spatial frequency content same. Therefore for the Dead-leaves chart and its variants, the scaling at different depths as mentioned above is not required. This makes the test scene setup easier. However if another texture, such as random noise, is used, the scaling may be required. A scene containing this depth target is digitally rendered. Images of this scene, captured by different cameras of the multi-camera array, are simulated. Image simulation includes all the optical, color and noise effects which are observed in real camera images. The resulting images are then fed into the depth (disparity) estimation algorithms.

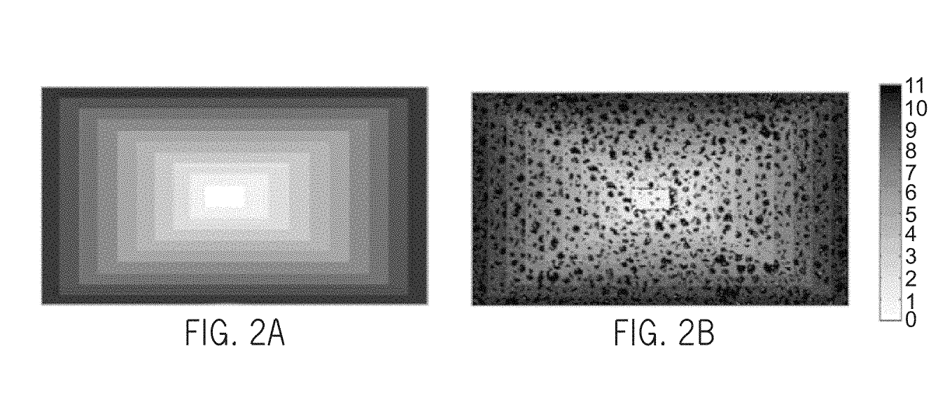

The ground truth depth map and computed depth map are shown in FIGS. 2A and 2B, respectively. The bar shows distances in meters. The black patches (FIG. 2B) in the resulting depth map are regions where the particular disparity algorithm used is unable to estimate depth. This is because these regions have lower spatial frequency content than required by this particular algorithm. This example demonstrates that the test target can also be used to characterize the limitations of the algorithms.

FIG. 3A shows the geometry of the tested two systems. To compare the performances of the two systems, the errors in depth measurement (with respect to the ground truth) are shown in FIG. 3B. The dashed line bars and dashed curve are for the 2+1 camera system. The theoretical curves, which depend on the widest baseline, are also shown. The results show that the 6+1 camera system is better both for depth accuracy and depth range than the 2+1 camera system. As known from theory, the simulated results also indicate that the error in disparity measurement is also dependent on depth of the system. The simulation results reasonably follow the theoretical values. However they do not exactly match the theoretical values because the theoretical values are calculated with the same disparity error at each depth. But in practice, the disparity error could be slightly different at different depths because of variation in texture, color, optical aberration and lighting with depth.

The depth error is theoretically determined by the following formula:

$$depth error = \frac{{depth}^{2} \times disparity error}{focal length \times baseline}$$

showing that the error in depth measurement depends on disparity error, focal length of the lens, depth of the imaged object and maximum baseline (i.e. distance between end cameras) of the system. In the two systems, all parameters are the same except for the disparity error, which is different because of number of cameras in the systems and the algorithm used. The plot in 3B shows that error in depth or disparity is lower if more cameras are used.

Thus, the depth target and the measurement metric are useful for determining depth measurement performance of the whole system for comparison and also allow assessment of individual algorithms.

Depth sensors have different depth ranges depending upon the technology they use and the applications they are designed for. For example, some sensors are designed for gesture recognition and only work for the range of few centimeters to couple of meters, whereas, some sensors work in the range of a 1 meter to 10 meters. Given the different ranges of operation, the depth target needs to be modified to accommodate for testing within the required range. The boards in the test target have to be placed within depth sensing range of a particular system.

Moreover, the boards can be tilted to estimate depth resolution of the system. The boards can be tilted in vertical or horizontal or both directions to determine the resolution of the system along that direction. Resolution relates to how continuous or fine is the measurement. Algorithms mostly quantize disparity measurement for speed and storage purposes.

Estimation algorithms for image based depth measurement systems depend on scene texture (in other words spatial frequency content) and on camera response to the scene texture. In these systems, generally, low texture in the final image gives poor performance whereas higher texture gives better performance. Therefore, the scene should have high spatial frequency content for depth estimation. The Dead-leaves chart has been found to represent texture for most natural scenes, has a wide range of spatial frequencies and most importantly is scale invariant to distance between the camera and the chart. Therefore the colored Dead-leaves chart may be used in the depth test target for image-based depth measuring systems.

However, for other depth measurement methods, such as structured illumination and time of flight, the pattern displayed doesn't matter since they are not image based. However, a material with higher reflection in infrared range is desired for these methods. So the boards may be coated with such materials.

In the following discussion, one disparity estimation algorithm useful in some embodiments is described. Other algorithms may also be used, including but not limited to disparity estimation by phase matching, graph cut or block matching. A hybrid camera array poses technical difficulties in matching across images from different types of sensors (sensors might have different resolutions, color characteristics, noise patterns, etc.). Given all the images from multiple cameras, images may be downsized to the same resolution as the lowest resolution camera. By doing that, all images have the same resolution and can efficiently perform pixel-to-pixel correspondence search in a disparity calculation. Images will then be transformed to new features representations. Since the color characteristics, noise patterns are quite different across different cameras, the variance may be reduced depending on what features are extracted to represent images. For example, if RGB color is used as features, “color histogram normalization” may be used to match images to the same color characteristics as the reference camera. If grayscale is used as features, “intensity histogram normalization” may be used to match images to the same intensity characteristics as the reference camera. Features such as gradient, census, local binary pattern (LBP) are less sensitive to color variations, but sensitive to noise, hence “noise normalization” may be used to match images to the same noise characteristics as the reference camera.

Once features are extracted, a multi-baseline disparity algorithm can be implemented. First, an adaptive shape support region instead of a fixed size region is desired for accurate disparity estimates. Therefore only the pixels of the same depth are used for sum of absolute difference (SAD) calculation in one embodiment. To find the adaptive shape support region, each pixel (x, y) will extend to four directions (left, right, up and down) until it hits a pixel that the color, gradient or grayscale difference between this pixel and the pixel (x, y) is beyond certain thresholds. For each pair of cameras (Cr—reference camera versus Ci—the other camera), and each candidate disparity d=(dx, dy), where dx and dy are the candidate disparity on horizontal and vertical direction calculated using baseline ratio dx=d*bi_x/bi and dy=d*bi_y/bi, construct a support region for each pixel (x, y) in Cr and corresponding comparing pixel (x+dx, y+dy) in Ci. Repeat the same process to construct support regions for all pixels.

Second, for each pair of cameras Cr and Ci, initialize pixel-wise absolute difference (AD) using features at each candidate disparity d. Equation 1 shows an AD calculation for each pixel (x, y):

ADᵢ(d)=┌lᵣ(x+k,y+t)−lᵢ(x+k+dₓ,y+t+d_{y}┐ (1)

Third, for each pair of cameras Cr and Ci, aggregate the AD errors using a sum of absolute difference (SAD) in the support region S using integral image techniques for efficient calculation:

$${SAD}_{i} ( d ) = {\sum }_{( k , t ) ∈ {S}_{i , r} ( d )} \vert {I}_{r} ( x + k , y + t ) - {I}_{i} ( x + k + {d}_{x} , y + t + {d}_{y} ) \vert \qquad ( 2 )$$

Fourth, resize all the pairwise SAD error costs between cameras Cr and Ci to the longest baseline based on baseline ratio using bilinear interpolation, and aggregate them together using an aggregate function. The aggregate function could, for example, either be SADᵢ(d) with the minimum error or a subset of {SADᵢ(d)} with minimum error and take the average.

$$E ( d ) = aggregate ( SAD \begin{matrix}resized \\ 1\end{matrix} ( d ) ) \qquad ( 3 )$$

Finally, multi-baseline disparity value for a given pixel (x,y) in the reference camera along the longest baseline is calculated by finding the minimum d in the summarized error map from all camera pairs:

$$d ( x , y ) = \begin{matrix}arg min \\ d\end{matrix} E ( d ) \qquad ( 4 )$$

Disparity from step 2 might contain noise. In order to get cleaner and smoother disparity output, a refinement step removes noise and low confident disparity values. Methods such as the uniqueness of global minimum cost, variance of the cost curve, etc. may be used. Then a median filter, joint bilateral filter, etc., may be used to fill holes that got removed in the previous step. Finally, if disparity map's resolution is lower than the original resolution of the reference camera image, the disparity map is upscaled to the same resolution as reference camera.

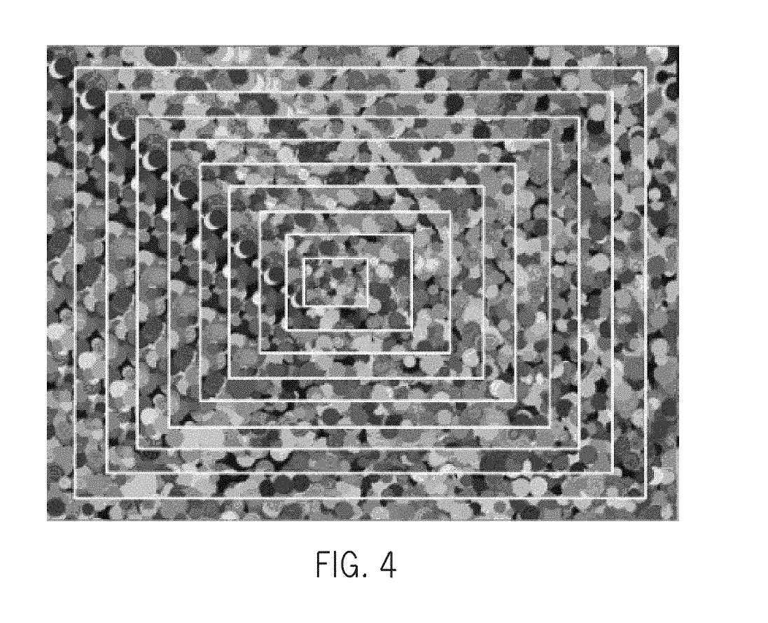

FIG. 4 shows an image of a 3D depth target with colored Dead-leaves charts at different depths. One of these texture charts may be placed to determine depth measurement accuracy. If color, dynamic range and other responses of the cameras need to be characterized simultaneously with depth, test charts for these can also be placed on the stacked boards. One example of a use case is multiple cameras may have different color response, so a Macbeth color checker may be placed in the front. That will give color response of each camera and ability to compensate for differences.

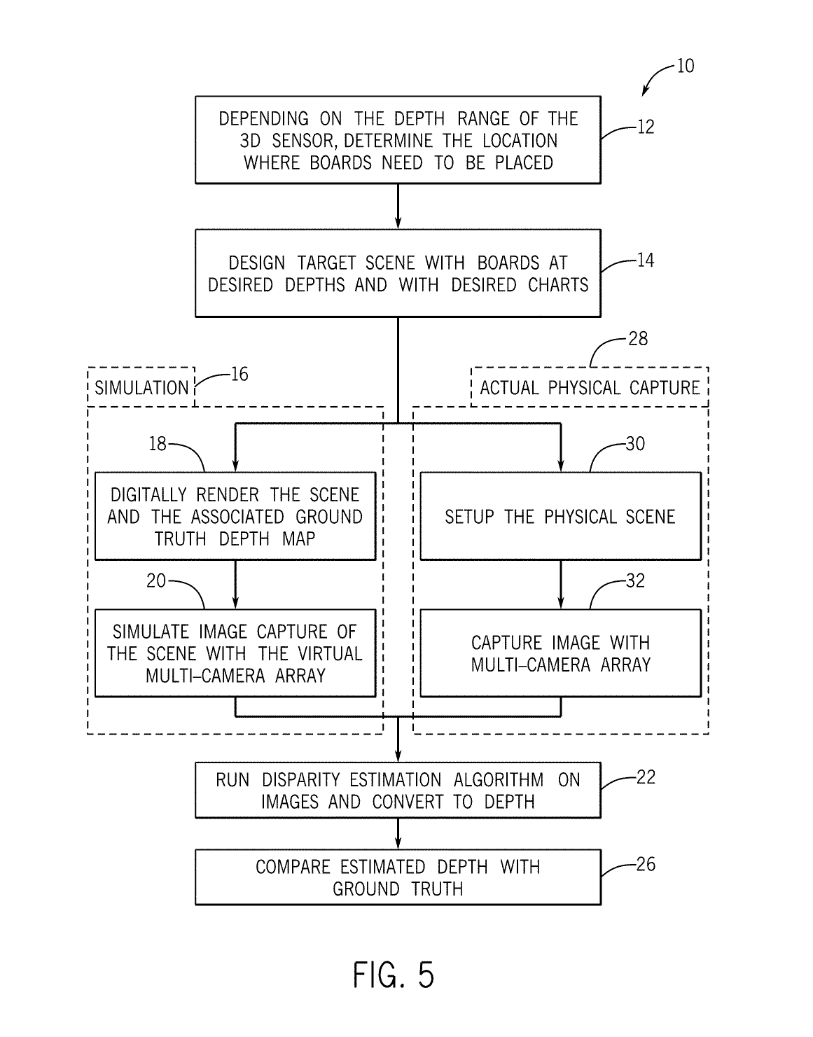

A method to design and test with the depth target is described in the flow chart 10 shown in FIG. 5. The flowchart shows both the simulation 16 and physical 28 testing paths. Either of these methods can be used and is independent of one another. Simulation is easier because the ground truth is exact.

The simulation testing path 16 including the steps set forth in blocks 12, 14, 18, 20, 22 and 26 may be implemented in software, firmware and/or hardware in some embodiments. In software and firmware embodiments these steps may be implemented by computer executed instructions stored in one or more non-transitory computer readable media such as magnetic, optical or semiconductor storages.

Depending on the depth range of the three-dimensional sensor, the locations where boards need to be placed to be within that depth range is determined as indicated in block 12. In the simulated embodiment, an image of the boards is designed instead of using physical boards. Then the target scene with the physical or virtual boards is designed at the desired depths and with the desired charts as indicated in block 14. In the simulation testing path 16 the scene is digitally rendered and the associated ground truth depth map is digitally rendered (block 18). The image capture of the scene is simulated with the virtual multi-camera array as indicated in block 20.

In the actual physical capture depth testing sequence 28, the physical scene is set up as indicated at 30 and the image is captured with a multi-camera array as indicated in block 32.

In both the simulation and actual physical capture, the disparity estimation algorithm is run on the images and the result is converted to depth as indicated in block 22. Finally the estimated depths are compared with the ground truth in block 26.

A combination of the previously existing Dead-leaves chart and use of charts at different depth positions allows evaluation of image based depth sensing systems. Thus, this idea uses the Dead-leaves chart for depth testing which has not been proposed before.

A computer simulated test target may be used for system performance evaluation. The computer generated 3D test scenes may be used in camera simulation. The advantage, in some embodiments, is knowledge of exact ground truth depth map for evaluation.

Computer-graphics generated images may be used as the scenes to be captured by the camera. These scenes may be generated with much higher spatial and color resolution than the camera, without any distortions seen in the real cameras. In multi-camera systems, the spatial separation between the cameras induces parallax in the captured images such that objects at different depths are seen shifted laterally between the images. For multi-camera systems, images for a single scene are generated from multiple viewpoint depending upon the geometry of the cameras. These images then serve as input scenes for the cameras.

Once the 2D projection of the scene is created, the scene image is converted to the optical image by light propagation methods. Light sources in 3D models determine the scene illumination and parameters like the type of light source (lambertian, point, diffuse, extended). The color temperature of the light and the luminance (brightness) can be controlled in the 3D model.

This high resolution version of the scene is propagated to the lens entrance-pupil. The scene is then processed such that the lens forms a de-magnified image of the scene on the sensor plane. Lens aberration and diffraction effects are faithfully imparted to the image generated on the sensor-plane. Various effects such as lens-to-lens misalignment, stray-light effects are also modelled.

The model includes opto-mechanical aspects of the camera module i.e. the alignment between the optical axis of the lens and the sensor center. It includes lens back-focal-length variations and error in the sensor position with respect to the lens focal plane. Thermal effects and other mechanical effects which manifest as one of the optical aberrations in the final image are also included in the model.

The sensor samples the scene and creates an image adding noise from sources such as shot-noise, read-noise, photo-response-non-uniformity, fixed pattern noise, pixel-cross-talk and other electronic noise sources. Other aspects of the sensor, such as photon to electron conversion, finite pixel size, color filters and efficiency of light conversion, etc. are taken into account in the sensor model.

The “raw” image from the sensor is processed by a typical camera image-signal processing pipe to deliver an RGB image from each camera sub-system. All these RGB images are fed into a “multi-camera” image signal processor (ISP) to extract disparity, depth and similar multi-camera parameter. These RGB images and their “multi-camera” metadata are sent to the media-view which renders the special effects as chosen by the end-user. The simulation may model all these aspects with high accuracy.

During the process of generating the computer-generated scenes at the onset, a “ground-truth depth-map” of the scene is generated with respect to each of the cameras. Having the “ground-truth” allows a comparison with the performance of our disparity and depth extraction algorithms as a function of various parameters such as texture, illumination, field-position, object distance and other characteristics. This analysis is highly desirable since passive-depth measurement is scene dependent and often has to be tested exhaustively over a range of scenes.

In the scene simulation part, high spectral resolution information about the scene is gathered enabling testing of the chromatic fidelity of the camera system if needed.

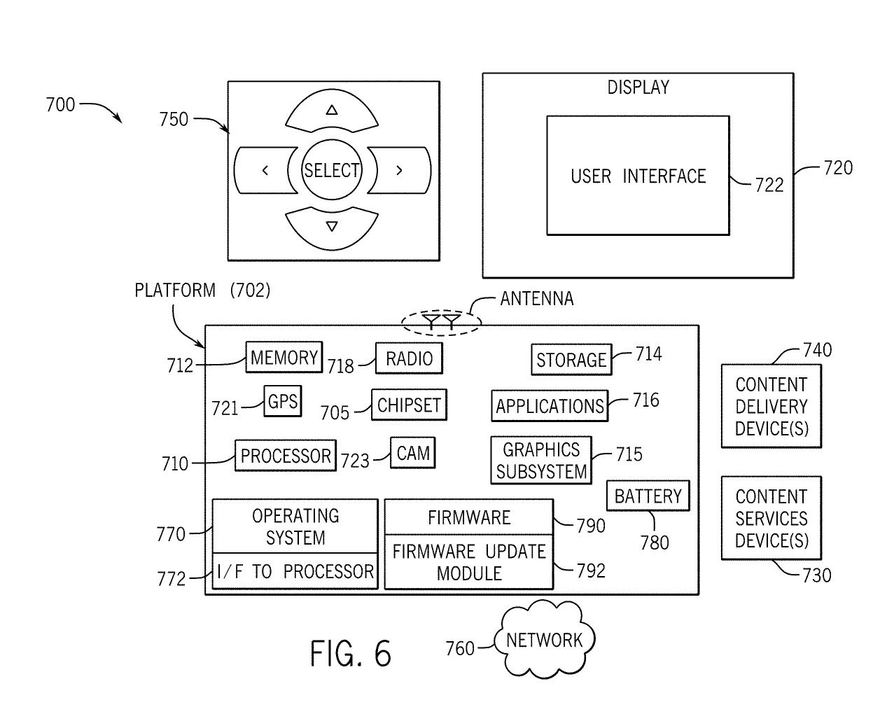

FIG. 6 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequence of FIG. 5 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 6.

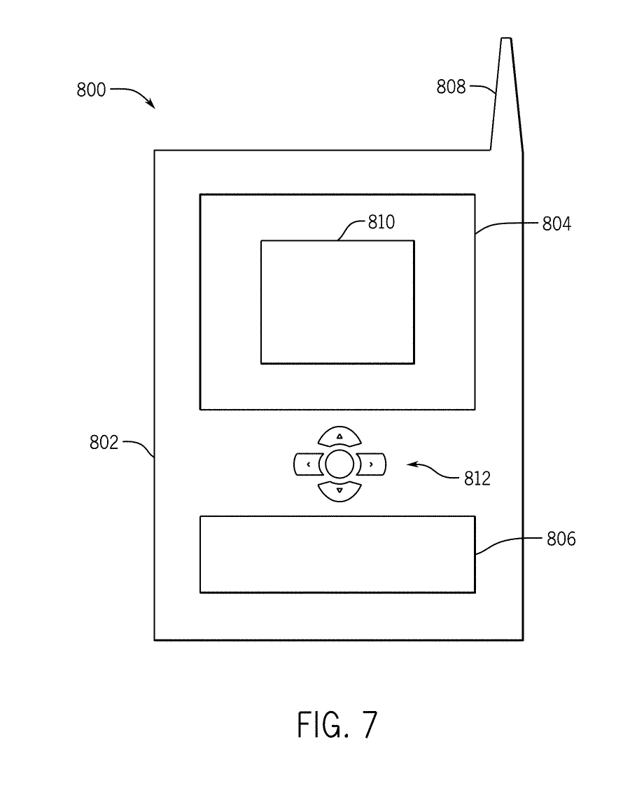

As described above, system 700 may be embodied in varying physical styles or form factors. FIG. 7 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The processing techniques described herein may be implemented in various hardware architectures. For example, the functionality may be integrated within a chipset. Alternatively, a discrete processor may be used. As still another embodiment, the functions may be implemented by a general purpose processor, including a multicore processor.

The following clauses and/or examples pertain to further embodiments:

One example embodiment may be a test target for testing depth measuring ability comprising an array of planar boards of successively larger size placed in different but known depths, and said boards depicting colored Dead leaves. The target may also include where boards are progressively scaled up by an amount that depends on the distance from a camera. The target may also include wherein an edge of each board is less than 2*z*tan(θ/2), where z is distance of the board from the camera and θ is field of view of the camera. The target may also include wherein the distance from the camera is z2 is greater than a distance z1, the displayed pattern on the board at distance z2 is scaled by a factor of z2/z1 with respect to the pattern on the board at distance z1. The target may also include wherein the boards are within the depth sensing range of a camera system to be tested.

Another example embodiment may be a method comprising arranging a test target in the form of a plurality of real or simulated spaced apart planar boards of successively larger size, said boards depicting Dead colored leaves, within the depth range of a camera system to be tested, and designing a target scene. The method may also include digitally rendering the scene and the associated ground truth map. The method may also include simulating image capture of the scene with a virtual multi-camera array. The method may also include running a disparity estimation algorithm on the images. The method may also include converting the images to depths. The method may also include comparing an estimated depth to ground truth.

In another example embodiment one or more non-transitory computer readable media storing instructions executed to perform a sequence comprising arranging a test target in the form of a plurality of images of spaced apart planar boards of successively larger size, said boards depicting Dead colored leaves, within the depth range of a camera system to be tested, and designing a target scene. The media may include said sequence including digitally rendering the scene and the associated ground truth map. The media may include said sequence including simulating image capture of the scene with a virtual multi-camera array. The media may include said sequence said sequence including running a disparity estimation algorithm on the images. The media may include said sequence including converting the images to depths. The media may include said sequence including comparing an estimated depth to ground truth.

Another example embodiment may be an apparatus comprising a hardware processor to arrange a test target in the form of images of a plurality of spaced apart planar boards of successively larger size, said boards depicting Dead colored leaves, within the depth range of a camera system to be tested and design a target scene, and a storage coupled to said processor. The apparatus may include said sequence including digitally rendering the scene and the associated ground truth map. The apparatus may include said sequence including simulating image capture of the scene with a virtual multi-camera array. The apparatus may include said sequence including running a disparity estimation algorithm on the images. The apparatus may include said sequence including converting the images to depths. The apparatus may include said sequence including comparing an estimated depth to ground truth. The apparatus may include boards of successively larger size placed in different but known depths and said boards depicting colored Dead leaves. The apparatus may include a battery coupled to the processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. An apparatus comprising:
a hardware processor to simulate a test target in the form of images of a plurality of spaced apart planar boards of successively larger size, said boards depicting Dead colored leaves, within the depth range of a camera system to be tested and to design a target scene; and
a storage coupled to said processor.

2. The apparatus of claim 1, said processor to digitally render the scene and an associated ground truth map.

3. The apparatus of claim 2, said processor to simulate image capture of the scene with a virtual multi-camera array.

4. The apparatus of claim 1, said processor to run a disparity estimation algorithm on the images.

5. The apparatus of claim 4, said processor to convert the images to depths.

6. The apparatus of claim 5, said processor to compare an estimated depth to ground truth.

7. The apparatus of claim 1 including boards of successively larger size placed in different but known depths and said boards depicting colored Dead leaves.

8. The apparatus of claim 1 including a battery coupled to the processor.

9. An apparatus comprising:
means for developing a test target in the form of a plurality of images of spaced apart planar boards of successively larger size, said boards depicting Dead colored leaves, within the depth range of a camera system to be tested; and
means for running a disparity estimation algorithm.

10. The apparatus of claim 9, including means for digitally render the scene and the associated ground truth map.

11. The apparatus of claim 10, including means for simulating image capture of the scene with a virtual multi-camera array.

12. The apparatus of claim 11, including means converting the result of said algorithm to depth.

13. The apparatus of claim 12, including means for comparing an estimated depth to ground truth.

14. An apparatus comprising:
a processor; and
a storage storing instructions to perform a sequence comprising:
developing a test target in the form of a plurality of images of spaced apart planar boards of successively larger size, said boards depicting Dead colored leaves, within the depth range of a camera system to be tested; and
running a disparity estimation algorithm.

15. The apparatus of claim 14, said sequence including digitally rendering the scene and the associated ground truth map.

16. The apparatus of claim 15, said sequence including for simulating image capture of the scene with a virtual multi-camera array.

17. The apparatus of claim 14, said sequence including converting the result of said algorithm to depth.

18. The apparatus of claim 17, said sequence comparing an estimated depth to ground truth.
